(19) United States
(12) Patent Application Publication
(10) Pub. No.: US 2002/0078139 A1
(43) Pub. Date: Jun. 20, 2002

(54) System and method of administering exam content

(75) Inventor: Rabindranath Dutta, Austin, TX (US)

Correspondence Address: Cynthia S. Byrd, International Business Machines Corporation, Intellectual Property Law Department, Internal Zip 4054, 11400 Burnet Road, Austin, TX, 78758, US

(73) Assignee: INTERNATIONAL BUSINESS MACHINES CORPORATION, ARMONK, NY (US)

(21) Appl. No.: 09/740,528

(22) Filed: Dec. 18, 2000

(51) Int. Cl. G06F 15/16

(52) U.S. Cl. 709/203

(57) ABSTRACT

A method and system for administering exam content is provided. A server adapted to receive requests from an exam provider to register at least one exam with the server registers the exams and displays the exams for students. The student's answers to at least one exam question are recorded at the server where they are graded and placed in a transcript which may be viewed by third parties having access to the server.

### TECHNICAL FIELD

The present invention relates to a system and method of administering exam content to a variety of users over a network.

### BACKGROUND OF THE INVENTION

Learning has traditionally taken place in a classroom where students and instructors come together in a common meeting place. With the increased widespread use of the World Wide Web and the Internet, much of this learning takes place over the web with the students and teachers in remote locations.

Software companies have developed certification exams to provide a standard for measuring an individual's ability in a particular area. Certification exams are typically given at a designated test center where the student identification is verified by a third party proctor.

Testing whether conducted by educational institutions or third party exam services is typically carried out by requiring the student to physically be present for the examination. The proctor administers the exam and monitors the students to prevent cheating. Physically monitoring the testing event is time consuming and expensive. In addition, the student must arrange his or her schedule to attend at a particular site which is not always convenient. Remote testing centers are proposed as a solution to this problem, however the remote centers still require the student to arrange his or her schedule to get to the remote center.

Another drawback of the conventional testing scheme is that each individual institution must administer their own exams. Verification typically is provided in the form of a certificate or degree showing that a particular student successfully completed a course of study.

The World Wide Web of the Internet is the most successful distributed application in the history of computing. In the Web environment, client machines effect transactions to Web servers providing users access to files (e.g., text, graphics, images, sound, video, etc.) using a standard page description language known as Hypertext Markup Language (HTML). HTML provides basic document formatting and allows the developer to specify “links” to other servers and files. The architecture of the Web follows a conventional client-server model. The terms “client” and “server” are used to refer to a computer's general role as a requester of data (the client) or provider of data (the server). Under the Web environment, Web browsers reside in clients and Web documents reside in servers. A browser opens a connection to a server and initiates a request for a document. The server delivers the requested document, typically in the form of a text document coded in HTML format. A network path to a server is identified by a so-called Uniform Resource Locator (URL) having a special syntax for defining a network connection. Use of an HTML-compatible browser (e.g., Netscape Navigator) at a client machine involves specification of a link via the URL. In response, the client makes a request to the server identified in the link and receives in return a document formatted according to HTML architecture.

A system for administering all types of exams via a Web server would be highly desirable. Currently there is not a system that allows the exam provider to submit the exam to a central server where it can be administered to multiple students at one time in remote locations. In addition, there is no system that allows for third party verification of the exam results. Independent third party verification of exam results over a network would be highly desirable.

There is a need for a server-client system for administering exams that is accessible to third parties and which would alleviate the above referenced drawbacks.

### SUMMARY OF THE INVENTION

The present invention provides a method of administering exam content from a server to a number of clients over a network. The server receives a request from an exam provider to register at least one exam with the server. Exams, including at least one exam question are provided to students over the network. An exam result is generated based on answers submitted by the student to the at least one question. A transcript is generated including the exam result. Access to the transcript is provided to at least one third party. Typical third parties include employers, admission review boards and the like.

A system for administering exam content to students over a network is also provided. The system comprises a means for receiving, at a server, a request from an exam provider to register at least one exam with the server; a means for providing an exam comprising at least one exam question to a student over the network; a means for generating an exam result based on answers submitted by the student to the at least one question; a means for generating a transcript including the exam result; and a means for providing access to the transcript to at least one third party.

A computer program product on a computer readable medium for use in a data processing system for administering exam content from a server to a number of clients over a network is also provided. The computer program product contains instructions for carrying out the method as disclosed herein.

### BRIEF DESCRIPTION OF THE DRAWINGS

The foregoing and other features and advantages of the present invention will become more apparent from the detailed description of the best mode for carrying out the invention as rendered below. In the description to follow reference will be made to the accompanying drawings, where like reference numerals are used to identify like parts in the various views in which:

FIG. 1 illustrates a distributed data processing system in which the present invention may be implemented;

FIG. 2 depicts a client communicating with a server to obtain access to exam files located on the server according to the present invention;

FIG. 3 depicts an example of a client-server system connected through a network;

FIG. 4 is a block diagram illustrating a data processing system which may be implemented as a client in accordance with a preferred embodiment of the present invention;

FIG. 5 is a block diagram depicting a data processing system which may be implemented as a server in accordance with a preferred embodiment of the present invention;

FIG. 6 is an example of a client computer system in which the present invention may be implemented;

FIG. 7 is a block diagram depicting software components which may be found within an exemplary client system suitable for use by a student according to the present invention;

FIG. 8 is a block diagram depicting software components which may be present on an exemplary web server suitable for use in the present invention;

FIG. 8A is an example of a graphical user interface (GUI) window displayed by a web server;

FIG. 8B is a flow diagram of a process followed by a student registered to take an exam that resides on an exam web server in accordance with the present invention;

FIG. 8C is a flow diagram of an exemplary process followed by a student registered to take an exam that resides on an exam web server in accordance with the present invention;

FIG. 8D is a flow diagram of an exemplary process followed by an exam grader in accordance with the present invention;

FIG. 8E is a flow diagram of an exemplary process followed by a third party wishing to access a student transcript in accordance with the present invention;

FIG. 9A is a diagram of an exemplary graphical user interface window displaying a student's transcript; and

FIG. 9B is a block diagram of the content of a data structure on the web server for the transcript shown in FIG. 9A.

### DETAILED DESCRIPTION OF THE PREFERRED EMBODIMENT

The present invention provides a system and method for administering exam content to a variety of clients over a network. The system and method enable multiple organizations and/or universities to register their exams with a central server that handles administration of the exams to multiple students in remote locations. The server is adapted to allow access to the exams for the purpose of providing exam questions as well as grading the exams taken by students. In addition, the server is adapted to provide access to third parties for review of the exam results of a particular student and a video image of the student if desired.

The system employs a web server communicatively connected to the clients via a network and is operative to disseminate as well as receive exam questions, exam answers, images, and any other exam related information. Users communicating with the server through client machines, typically include students, exam providers, such as universities and companies, exam content providers, potential employers, and any other third party that is granted access to the exam files.

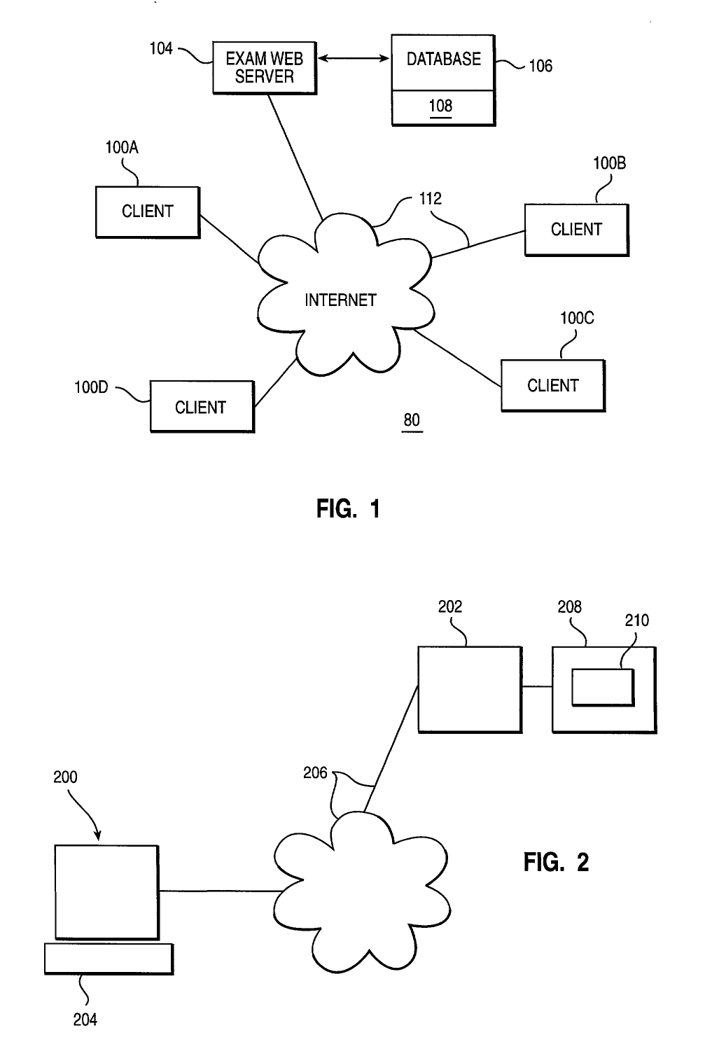

FIG. 1 illustrates a distributed data system 80 in which the present invention may be implemented. In this environment, one or more user operated clients 100 A-D, are capable of accessing web application server 104 via a network 112. Web application server 104 includes a database 106 that contains exam files 108. The term “exam files” as used herein refers to prepared exams, exam answers provided by a student, graded exams, and exam content, including questions and answers submitted by content providers. A user of a browser at client 100 can access the exam files 108 located on web application server 104. The web application server 104 may be linked to other servers operable to store exam files and/or registration information as needed. The clients may include students desiring to take an exam, companies wishing to register their exams with the server, exam grading entities, exam content writers, and third parties that wish to examine the transcript of a particular student. The term “register” is used herein to describe the process where an exam provider effectuates the entry of exam questions for one or more exams on the server 104. The registered exams are then made available to students through the server. An example of an exam registration process is discussed in more detail below.

Network 112 is the medium used to provide communications links between various devices and computers connected together within distributed data processing system 80. Network 112 may include permanent connections, such as wire or fiber optic cables, or temporary connections made through telephone or wireless communications. Clients and servers may be represented by a variety of computing devices, such as mainframes, personal computers, personal digital assistants (PDAs), smart phones, etc. Distributed data processing system may include additional servers, clients, routers and other devices not shown. In the depicted example, the distributed data processing system 80 may include the Internet with network 112 representing a worldwide collection of networks and gateways that use the TCP/IP suite of protocols to communicate with one another. Of course, the distributed data processing system may also include a number of different types of networks, such as, for example, an intranet, a local area network (LAN), or a wide area network (WAN).

The present invention could be implemented on a variety of hardware platforms. In addition to being able to be implemented on a variety of hardware platforms, the present invention may be implemented in a variety of software environments. A typical operating system may be used to control program execution within the data processing system. Furthermore, although in the preferred embodiment described below, a “browser” at the client is the agent which exchanges data in the security protocols with the Web Application Server, the agent at the client does not have to be a conventional browser, e.g., Netscape Navigator® or Microsoft Internet Explorer®. In order to secure the information transmitted to and from the server, the client may be capable of Public Key Infrastructure (PKI) technology exchanged in a security protocol such as the Secure Sockets Layer (SSL) version 3.0 and above.

Web application server 104 includes a conventional server software program such as Internationl Business Machines' Websphere®, for administering the exam content. The server software includes application programs that enable the server 104 to administer the exam content in response to requests from the various clients 100A-D. More particularly, the web server 104 is capable of enabling users to register their exams with the server, transmitting exams to students, recording exam answers submitted by students, enabling exam graders to access the exam answers submitted by the students, producing exam results for each student, and enabling third parties to access exam results for a given student.

FIG. 2 is an example of a client accessing exam information located on a server according to the present invention. As illustrated, the user at a client workstation 200 seeks access over a computer network 206 to an exam file 210 located in a database 208 on a server 202 through the user's web browser 204. The computer network 206 may be the Internet, an intranet, or other network. Server 202 may be a Web Application Server (WAS) such as WAS 104 shown in FIG. 1, a server application, a servlet process or the like. Client 200 submits the required user information to identify themselves as being authorized to access the requested information. User information can include data such as a password or a combination of a user id and password assigned by the server 202. Web server 202 generates a graphical user interface that is displayed by the browser 204 providing the individual options to the client.

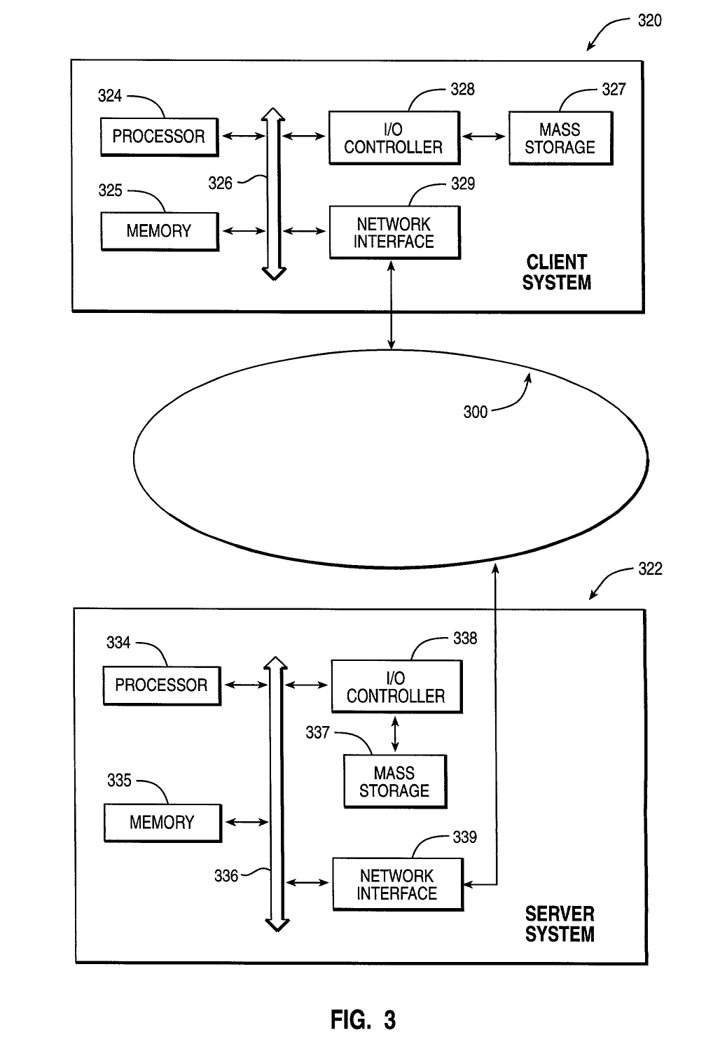

FIG. 3 depicts an example of a client-server system connected through the Internet 300. In this example, a remote server system 322 is connected through the Internet to client system 320. The client system 320 includes conventional components such as a processor 324, memory 325 (e.g. RAM), a bus 326 which couples the processor 324 and memory 325, a mass storage device 327 (e.g. a magnetic hard disk or an optical storage disk) coupled to the processor and memory through an I/O controller 328 and a network interface 329, such as a conventional modem. The server system 322 also includes conventional components such as a processor 334, memory 335 (e.g. RAM), a bus 336 which couples the processor 334 and memory 335, a mass storage device 337 (e.g. a magnetic or optical disk) coupled to the processor 334 and memory 335 through an I/O controller 338 and a network interface 339, such as a conventional modem. It will be appreciated from the description below that the present invention may be implemented in software which is stored as executable instructions on a computer readable medium on the client and server systems, such as mass storage devices 327 and 337 respectively, or in memories 325 and 335 respectively.

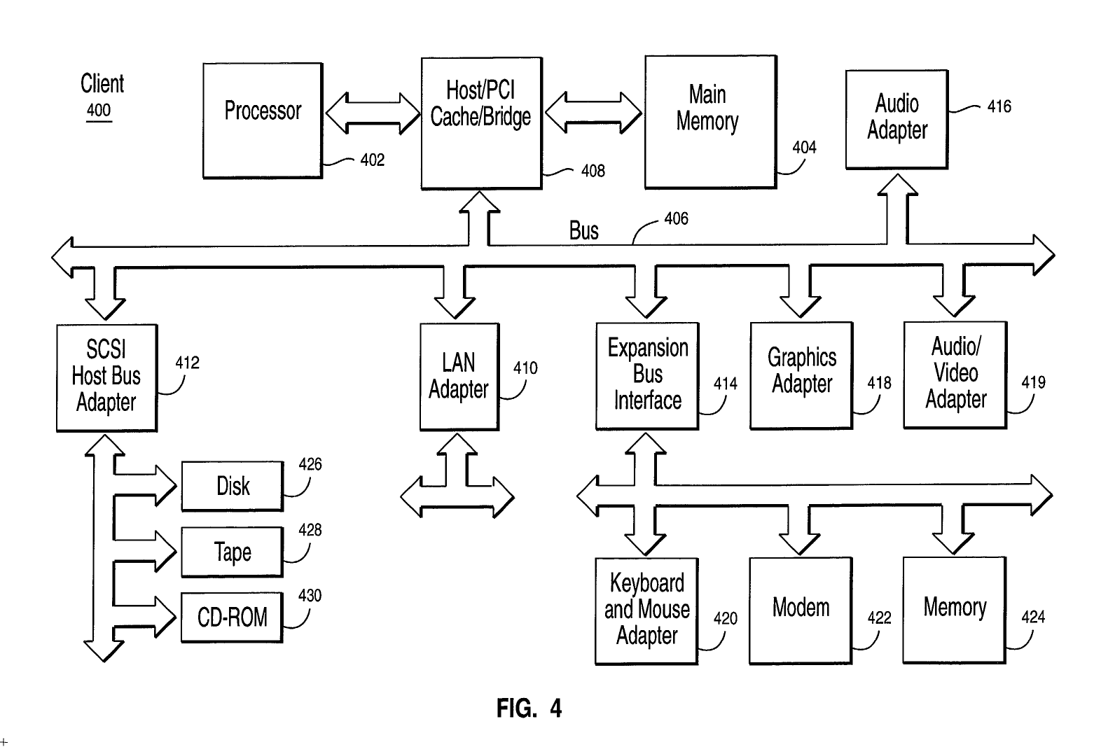

FIG. 4, is a block diagram illustrating a data processing system 400 which may be implemented as a client. Data processing system 400 employs a peripheral component interconnect (PCI) local bus architecture. Although the depicted example employs a PCI bus, other bus architectures, such as Micro Channel and ISA, may be used. Processor 402 and main memory 404 are connected to PCI local bus 406 through PCI bridge 408. PCI bridge 408 also may include an integrated memory controller and cache memory for processor 402. Additional connections to PCI local bus 406 may be made through direct component interconnection or through add-in boards. In the depicted example, local area network (LAN) adapter 410, SCSI host bus adapter 412, and expansion bus interface 414 are connected to PCI local bus 406 by direct component connection. In contrast, audio adapter 416, graphics adapter 418, and audio/video adapter 419 are connected to PCI local bus 406 by add-in boards inserted into expansion slots. Expansion bus interface 414 provides a connection for a keyboard and mouse adapter 420, modem 422, and additional memory 424. SCSI host bus adapter 412 provides a connection for hard disk drive 426, tape drive 428, and CD-ROM drive 430. Typical PCI local bus implementations support three or four PCI expansion slots or add-in connectors.

An operating system runs on processor 402 and is used to coordinate and provide control of various components within data processing system 400 in FIG. 4. The operating system may be a commercially available operating system such as a UNIX based operating system, AIX for instance, which is available from International Business Machines Corporation. “AIX” is a trademark of International Business Machines Corporation. Other operating systems include OS/2 and Microsoft Windows. An object oriented programming system, such as Java, may run in conjunction with the operating system and provide calls to the operating system from Java programs or applications executing on data processing system 400. “Java” is a trademark of Sun Microsystems, Inc. Instructions for the operating system, the object-oriented operating system, and applications or programs are located on storage devices, such as hard disk drive 426, and may be loaded into main memory 404 for execution by processor 402.

Those of ordinary skill in the art will appreciate that the hardware in FIG. 4 may vary depending on the implementation. Other internal hardware or peripheral devices, such as flash ROM (or equivalent nonvolatile memory) or optical disk drives and the like, may be used in addition to or in place of the hardware depicted in FIG. 4. Also, the processes of the present invention may be applied to a multiprocessor data processing system.

For example, data processing system 400, if optionally configured as a network computer, may not include SCSI host bus adapter 412, hard disk drive 426, tape drive 428, and CD-ROM 430. In that case, the computer, to be properly called a client computer, must include some type of network communication interface, such as LAN adapter 410, modem 422, or the like. As another example, data processing system 400 may be a stand-alone system configured to be bootable without relying on some type of network communication interface, whether or not data processing system 400 comprises some type of network communication interface. As a further example, data processing system 400 may be a Personal Digital Assistant (PDA) device which is configured with ROM and/or flash ROM in order to provide nonvolatile memory for storing operating system files and/or user-generated data.

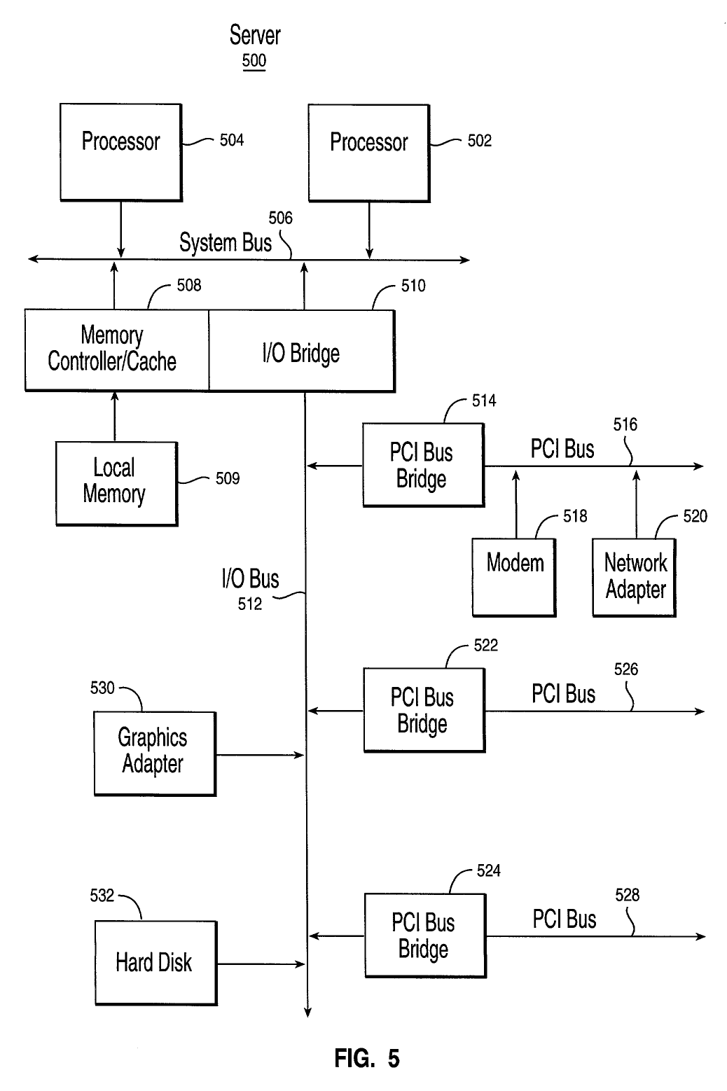

The depicted example in FIG. 5, as well as above-described examples, are not meant to imply architectural limitations.

Referring to FIG. 5, a block diagram depicts a data processing system which may be implemented as a server, such as server 104 in FIG. 1, in accordance with a preferred embodiment of the present invention. Data processing system 500 includes a processor 502 connected to system bus 506. Alternatively, a multiprocessor system may be employed. Also connected to system bus 506 is memory controller/cache 508, which provides an interface to local memory 509. I/O bus bridge 510 is connected to system bus 506 and provides an interface to I/O bus 512. Memory controller/cache 508 and I/O bus bridge 510 may be integrated as depicted.

Peripheral component interconnect (PCI) bus bridge 514 connected to I/O bus 512 provides an interface to PCI local bus 516. A number of modems may be connected to PCI bus 516. Typical PCI bus implementations support four PCI expansion slots or add-in connectors. Communications links to network computers 100 A-D in FIG. 1 may be provided through modem 518 and network adapter 520 connected to PCI local bus 516 through add-in boards. Additional PCI bus bridges 522 and 524 provide interfaces for additional PCI buses 526 and 528, from which additional modems or network adapters may be supported. A memory-mapped graphics adapter 530 and hard disk 532 may also be connected to I/O bus 512 as depicted, either directly or indirectly.

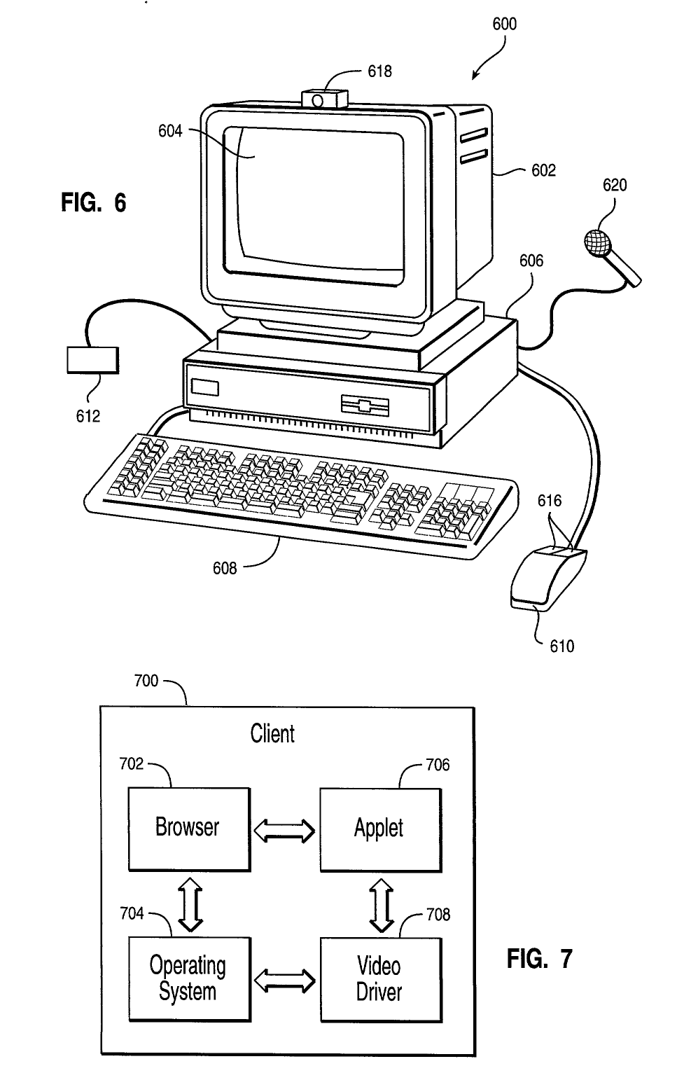

The client can run a browser on a client computer system, such as computer system 600 shown in FIG. 6. The computer system 600 includes a display device 602 (such as a monitor), a display screen 604, a cabinet 606 (which encloses components typically found in a computer, such as CPU, RAM, ROM, video card, hard drive, sound card, serial ports, etc.), a keyboard 608, a mouse 610, a microphone 620 and a modem 612. Mouse 610 may have one or more buttons, such as buttons 616. The computer system 600 also has a video camera 618 operatively associated with a video adapter (not shown) in the cabinet 606. The computer requires some type of communication device such as modem 612 that allows computer system 600 to be connected to the Internet. Other possible communication devices include ethernet network cards.

FIG. 7 is a block diagram of software components found within an exemplary client system 700 suitable for use by a student in the present invention. The client system 700 as shown has a conventional web browser 702 such as Netscape Navigator or Microsoft Internet Explorer running on an operating system 704. The browser 702 is used to communicate HTTP requests over the network with the exam web server. When a student submits a request to take an exam, in addition to sending the HTML formatted document, the server may send an applet 706 to the browser 702. The applet 706 communicates with the video camera driver 708 present on the client system and instructs the camera to record images of the student at random points in time during the exam. The images are transferred from the client computer to the server. When the student takes an exam, the applet instructs the video camera to take an initial picture of the student which can be used for identification purposes. In addition, subsequent images of the student may be taken at random points in time while the student is taking the exam. The applet for communicating with the video camera drivers is optional for the student client system. Other client systems referred to herein may contain the same basic software components for communicating requests to the exam server and receiving responses to the same.

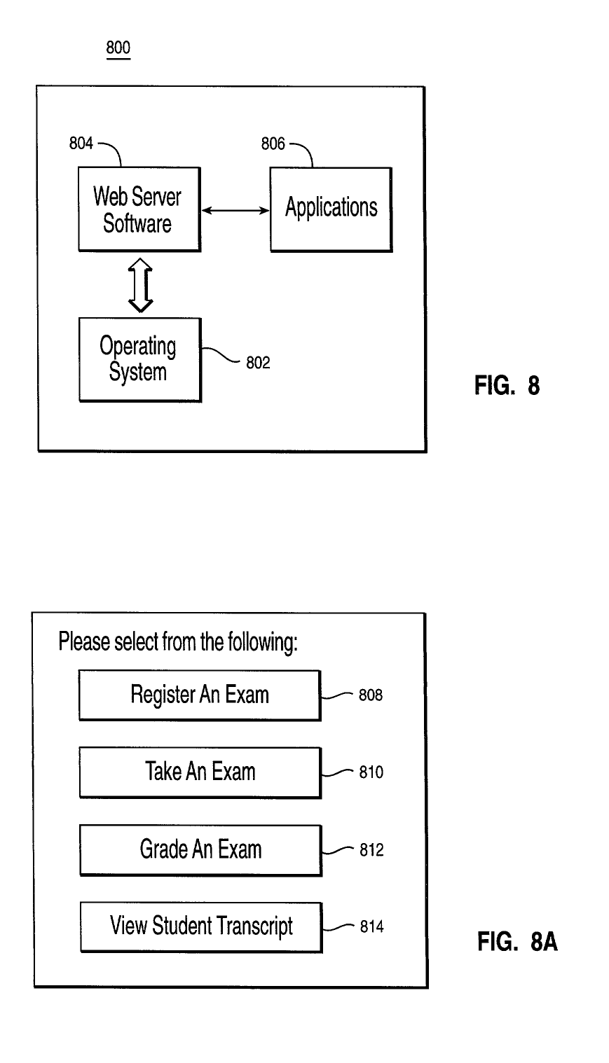

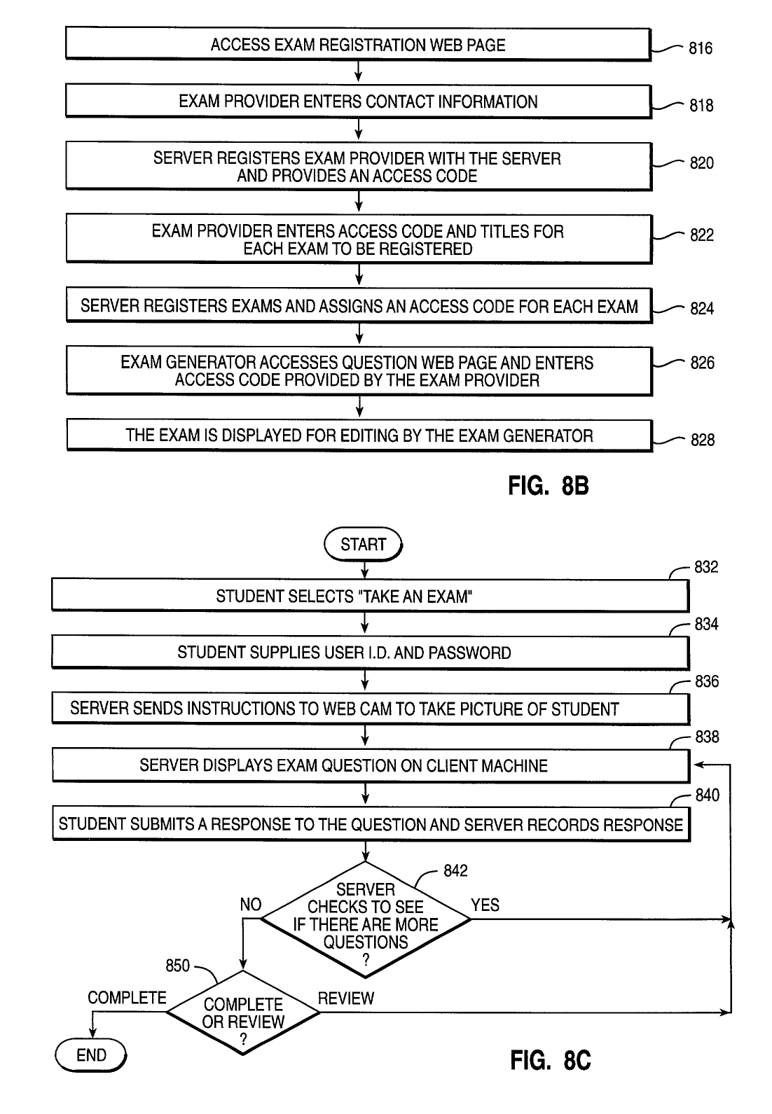

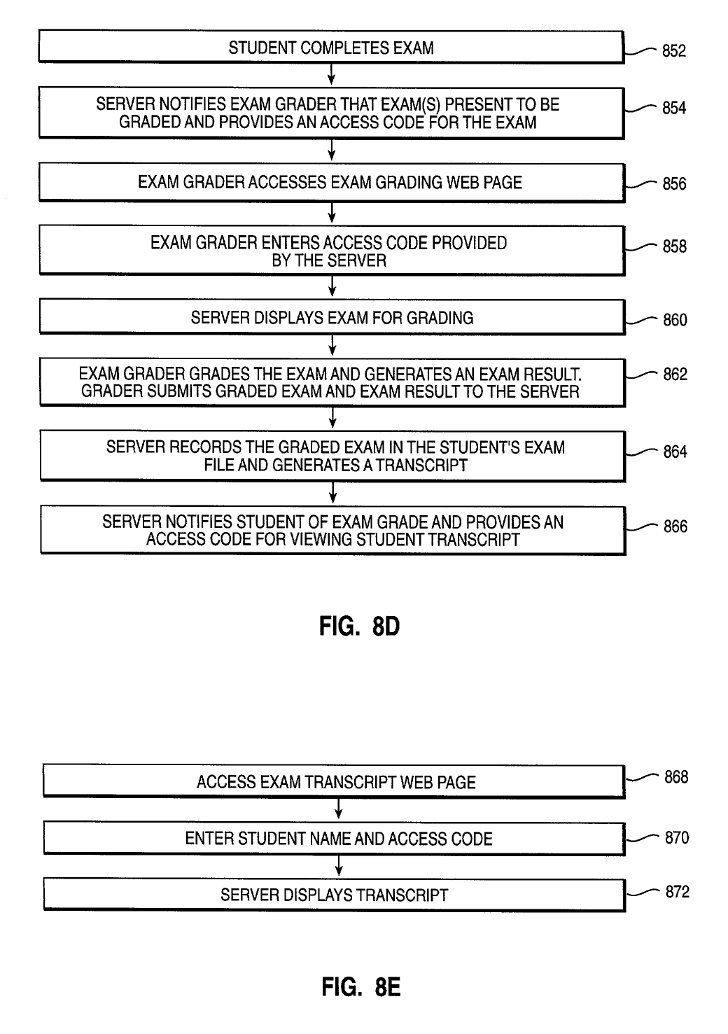

FIG. 8 is a block diagram of some of the software components present on an exemplary web server 800 suitable for use in the present invention. The web server 800 has an operating system 802 that runs a conventional web server software application 804 such as Websphere® available from International Business Machines. The server 800 has application programs 806 that process requests from the various clients including but not limited to 1) exam providers to register exams with the server, 2) students that wish to take exams on the server, 3) exam graders who grade completed exams, and 4) third parties that wish to view a transcript of a particular student. The web server software 804 receives the HTTP requests from the clients and transmits the requested information as appropriate.

FIG. 8A is an example of a graphical user interface (GUI) window 801 displayed by the web server 800. The GUI contains hyperlinks to the various applications 804 available on the web server 800 in accordance with the present invention. The web server displays the window 801 when a client enters in the URL for the exam web server. The arrangement of the links are meant to be illustrative and non-limiting. One of ordinary skill in the art could present the same information on the interface and achieve the same result of providing access to the various applications located on the server.

FIG. 8B is a flow diagram of an exemplary process followed by client companies and other institutions who want to register their exams with the web server, collectively referred to herein as exam providers. The exam provider selects button 808, shown in FIG. 8A, to access the exam registration web page, step 816. A page is presented which prompts the provider to enter their name, address and any other contact information, step 818. The server registers the exam provider and provides an access code, step 820. The exam provider then enters the access code and the titles for each exam to be registered, step 822. The server registers the exams and assigns an access code for each exam, step 824. The exam provider may enter the exam information at this point or hire a third party question generator to create the exam. If the exam provider hires a third party question generator to submit questions for a particular exam, the question generator selects button 808, shown in FIG. 8A, enters the access code, step 826. The exam is then displayed for editing by the question generator, step 828.

FIG. 8C is a flow diagram of an exemplary process followed by a student registered to take an exam that resides on an exam web server in accordance with the present invention. The student accesses the web server 800 and selects the option 810, shown in FIG. 8A, “take an exam”, step 832. The student enters a user id and password, step 834. The web camera on the student client machine takes a still photo of the student, step 836, The server then displays the first exam question on the student's client machine, step 838. The student answers the question and the response is recorded on the server, step 840. If there are more questions in the exam the program returns to step 838. When the student has answered all of the questions, they are prompted to complete the exam or review the exam, step 850. If they choose to review the exam they go back to step 838 to display the exam questions. If the student is finished with the exam then the process ends. The exam questions and answers are stored on the exam web server for access by an exam grader. The organization of the exam process can be easily modified by one of ordinary skill in the art. The chart shown in FIG. 8C is an example of one way to administer such an exam and is not intended to be limiting.

The server 800 may contain an exam grading application. FIG. 8D is a flow diagram of an exemplary process followed by an exam grader in accordance with the present invention. The student completes the exam, step 852. The server notifies the exam grader that their are exams on the server to be graded and provides the grader with an access code, step 854. The exam grader accesses the exam grading web page by selecting link 812, shown in FIG. 8A, step 856. The grader is prompted to enter the access code provided by the server, step 858. The server then displays the exam for grading, step 860. The grader grades the exam to generate an exam result. The exam result and the graded exam along with any comments are submitted to the server, step 862. The server then records the graded exam in the appropriate student exam file and generates a transcript, step 864. the exam, generating an exam result. The exam result is stored in an exam file on the web server database where it can be accessed by the student and/or third parties.

The server 800 may also contain a transcript application that enables authorized third parties to view a student's transcript for a particular exam as well as the exam given and the answers provided by the student. FIG. 8E is a flow diagram of an exemplary process followed by a third party wishing to access a student transcript in accordance with the present invention. The third party accesses the exam web server and selects the link 814, shown in FIG. 8A, to view a transcript, step 868. The web server then prompts the third party to enter the student name and a proper access code, step 870. The server then displays the transcript for the third party, step 872. The transcript is displayed, optionally along with at least one picture of the student taken during the exam. The student may change the access code at random, to limit access to the transcript.

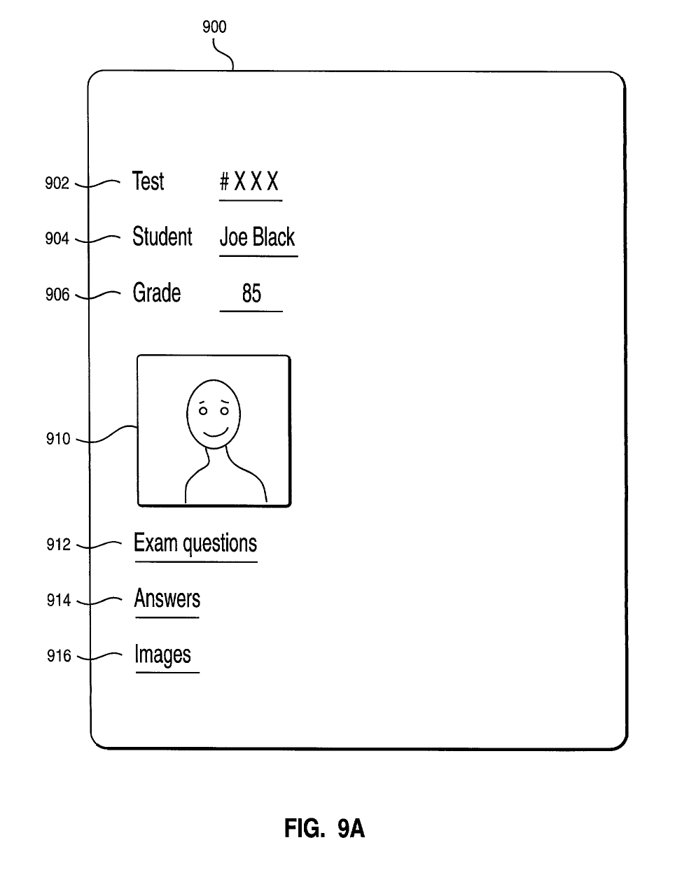

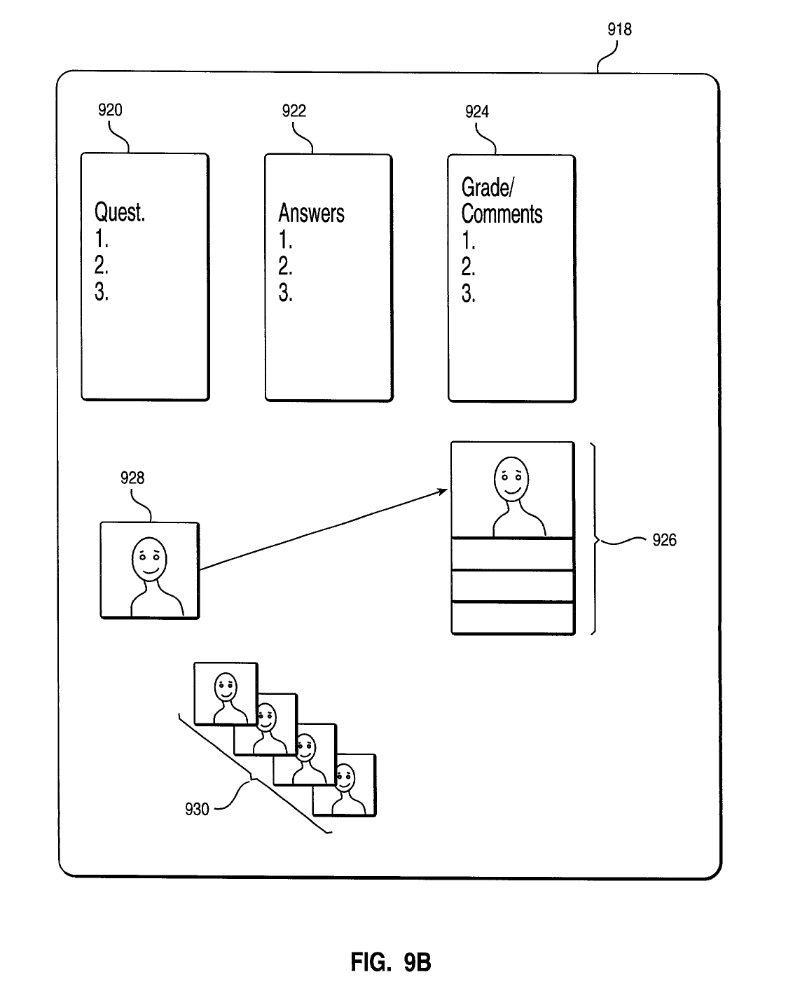

FIG. 9A is a diagram depicting an example of a graphical user interface window 900 displaying a student's transcript. This window 900 is displayed when the client sends a request to access a student transcript. The window 900 shows the exam number 902, the student's name 904 and the grade or exam result 906. There also is an image of the student 910 for verification of the student's identification if necessary. Links to the exam questions 912, answers 914 and additional images of the student taken during the exam 916 are also available.

FIG. 9B is a block diagram depicting an example of the content of data structures 918 on the web server for exam files stored on the server. Exam questions are shown in file 920, a student's answers to the questions are depicted in file 922 and grader's results and comments are shown in file 924. The exam files can be maintained separately as shown, linked in a relational database or other file system depending upon the user's needs. An image file 928 depicts a still photo of the student taken just before the exam, and image file 930 contains images of student taken at random during the exam. The exam result is displayed on a transcript 926 which may also contain image 928 of the student along with identification information such as the student's name and address etc. In operation, a link may be provided in the transcript 926 that when selected displays the questions asked, the answers, and the grader's comments where applicable. One of ordinary skill in the art could arrange the information in the data structure in a variety of ways depending upon how the user wants the information displayed.

There are several advantages to a client-server system for administering exam content. Multiple universities and other organizations can register their exams with the server instead of administering the exams themselves. The exam server provides access to the exam files for grading purposes; for viewing by third parties and for submitting questions if necessary. All of these functions are currently done separately. The use of proctors and reserving testing sites is virtually eliminated. The university or organization expense of maintaining an exam database is reduced if not eliminated. Third parties can view and verify exam results on-line without having to wait for paper transcripts. Visual verification of the student provides an additional safeguard against cheating on exams.

While the invention has been shown and described with reference to particular embodiments thereof, it will be understood by those skilled in the art that the foregoing and other changes in form and detail may be made therein without departing from the spirit and scope of the invention.

1. A method of administering exam content from a server to at least one client over a network, the method comprising:
registering at least one exam submitted by an exam provider with the server;
generating a transcript in response to answers submitted by a student to at least one exam question resident on the server; and
providing access to the transcript to at least one third party.

2. The method of claim 1 further comprising providing an exam content generator with access to registered exams on the server.

3. The method of claim 1 further comprising providing an exam grader with access to a student's answers on the server.

4. The method of claim 1 further comprising transmitting a video frame of the student to the server at at least one random point in time while the student is taking the exam.

5. The method of claim 4 wherein the transcript further comprises at least one video image of the student.

6. The method of claim 1 further comprising registering a plurality of exams with the server.

7. The method of claim 1 further comprising recording a student's answers to at least one exam question presented by the server; and
grading the student's answers to generate an exam result.

8. A system for administering exam content to a number of clients over a network comprising:
a processor;
a memory coupled to the processor;
a computer readable medium coupled to the processor, the computer readable medium containing executable program instructions for:
registering at least one exam submitted by an exam provider with the server;
generating a transcript in response to answers submitted by a student to at least one exam question resident on the server; and
providing access to the transcript to at least one third party.

9. The system of claim 8 further comprising instructions for providing the exam grader with access to the answers submitted by the student.

10. The system of claim 8 further comprising instructions for providing an exam content generator with access to the registered exams.

11. The system of claim 8 wherein the server comprises a means for accepting and storing video images of the student.

12. The system of claim 8 wherein the server comprises a means for registering a plurality of exams with the server.

13. The system of claim 8 wherein the server comprises a means for recording a student's answers to at least one exam question presented by the server; and
a means for grading the student's answers to generate the exam result.

14. A computer program product on a computer readable medium for use in a data processing system for administering exam content from a server to a number of clients over a network, comprising:
instructions for registering at least one exam submitted by an exam provider with the server;
instructions for generating a transcript in response to answers submitted by a student to at least one exam question resident on the server; and
instructions for providing access to the transcript to at least one third party.

15. The product of claim 15 further comprising
instructions for transmitting a video frame of the student to the server at at least one random point in time while the student is taking the exam.

16. The product of claim 15 further comprising instructions for providing an exam content generator with access to registered exams on the server.

17. The product of claim 15 further comprising instructions for providing an exam grader with access to a student's answers on the server.

18. The product of claim 15 further comprising instructions for registering a plurality of exams with the server.

19. The product of claim 15 further comprising instructions for recording a student's answers to at least one exam question presented by the server; and
instructions for grading the student's answers to generate the exam result.
